(19) United States
(12) Patent Application Publication
(10) Pub. No.: US 2024/0427045 A1
(43) Pub. Date: Dec. 26, 2024

(54) FIBER-SEISMIC TOMOGRAPHY

(71) Applicant: California Institute of Technology, Pasadena, CA (US)

(72) Inventors: Ettore Biondi, Pasadena, CA (US); Zhongwen Zhan, Arcadia, CA (US); Jiaxuan Li, Pasadena, CA (US); Weiqiang Zhu, Berkeley, CA (US)

(73) Assignee: California Institute of Technology, Pasadena, CA (US)

(21) Appl. No.: 18/752,231

(22) Filed: Jun. 24, 2024

Related U.S. Application Data
(60) Provisional application No. 63/522,801, filed on Jun. 23, 2023.

(51) Int. Cl. G01V 1/34; G01V 1/22; G01V 1/28; G01V 1/30

(52) U.S. Cl. CPC G01V 1/345; G01V 1/226; G01V 1/282; G01V 1/303

(57) ABSTRACT

A computer-implemented method useful for performing seismic tomography, including obtaining seismic data comprising distributed acoustic sensing (DAS) data, comprising at least one of P-wave or S-wave travel times from a plurality of seismic events to a plurality of recording stations coupled to a network of optical fibers in a geological structure; and generating tomography data from the DAS data, wherein tomography data is useful for characterizing the geological structure. We employ distributed acoustic sensing data recorded along a 100-km fiber-optic cable traversing the caldera to image its subsurface structure. Our images highlight a definite separation between the shallow hydrothermal system and the large magma chamber located at ˜12 km depth. The combination of the geological evidence with our results shows how fluids exsolved through second boiling provide the source of the observed uplift and seismicity. Thus Fiber-seismic tomography reveals that the unrest in the Long Valley Caldera is likely driven by fluid from second boiling, not new magma intrusion.

### CROSS-REFERENCE TO RELATED APPLICATIONS

This application claims the benefit under 35 U.S.C. Section 119 (e) of co-pending and commonly-assigned U.S. Provisional Patent Application No. 63/522,801, filed Jun. 23, 2023, entitled “Fiber-seismic tomography” by Ettore Biondi, Zhongwen Zhan, Jiaxuan Li, and Weiqiang Zhu (CIT-9029-P), which application is incorporated by reference herein.

### BACKGROUND OF THE INVENTION

### Field of the Invention

The present invention relates to methods and systems for performing tomography.

### Description of the Related Art

Conventional Seismic tomography is limited by the scale and resolution of the seismic arrays employed to form the tomographic images ([0077], [0083]-[0086]). The limited resolution has prevented meaningful geophysical characterization of subsurface structures for various applications. What is needed, then, are improved methods for performing seismic tomography. The present disclosure satisfies this need.

### SUMMARY OF THE INVENTION

The present disclosure describes a method and system using seismic data recorded using distributed acoustic sensing (DAS), deployed on existing telecommunication dark optical fibers, to perform subsurface imaging. DAS implements fiber optical cables as dense arrays of seismic channels stretching over kilometers. The imaging method can further increase resolution by selecting recorded earthquake arrival times using a machine-learning (ML) algorithm.

Successful application of the method to study the Long Valley Caldera is demonstrated using two DAS OptaSense Plexus units deployed to record more than 6000 local and regional earthquakes. The ML algorithm accurately picks more than 12 million P—and S-wave arrivals times. The study area in the Long Valley caldera in northern California presents significant volcanic activity (e.g., hot springs and fumaroles) since a large volume of magma is emplaced within the deep subsurface (below 10 km from the surface). Monitoring this region is essential to assess the volcanic hazard but also for the exploitation of geothermal energy. In fact, a 30 MW binary cycle geothermal power plant is currently generating energy in this region. We apply our efficient tomographic workflow to obtain high-resolution subsurface images. Compared to tables based on conventional, even dense, seismic arrays, DAS data provides arrival time tables with a total number of picks that is 2 to 3 orders of magnitude larger, which represents a computational challenge for existing tomographic approaches. Our approach properly takes into account complex ray geometries and handles a large number of ML-measured traveltimes within a double-difference (DD) Eikonal traveltime tomography workflow based on the adjoint-state method.

The increased resolution of the obtained tomographic images of the Long Valley caldera (based on full waveform inversion of surface waves between 6 and 20 s) is demonstrated by comparison with the latest tomography S-wave speed model. With the improved data coverage from the two DAS arrays, we substantially improved the model resolution in the top 15 km to 20 km. The heterogeneous shallow structures within the caldera, which only appear as a smooth low-velocity anomaly in the initial model, become sharp in our new tomographic model and correlate well with surface geology. These shallow velocities reductions are potentially related to the filling material deposited in the depression and the extensive surface hydrothermal system that could be employed to further expand the geothermal operations in the area. In addition, our results clearly highlight the disconnection between the shallow structures and the large magma chamber at depths below 8 km. More generally, our results demonstrate how the existing telecommunication infrastructure can be used for high-resolution seismic imaging for geophysical purposes.

This imaging technology has multiple applications including, but not limited to, geothermal prospect exploration, subsurface monitoring for carbon sequestration, and characterization of subsurface properties for earthquake amplification factor estimation.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Referring now to the drawings in which like reference numbers represent corresponding parts throughout:

FIG. 1. Flowchart illustrating a method of generating tomographic data.

FIG. 2. Flowchart illustrating a method of generating tomographic data by minimizing objective functions.

FIGS. 3A-3C. Study area and local and regional events from DAS array. (A) Map of the study area in which the DAS channels (green line), seismic stations (blue triangle), and earthquakes (red dots) are indicated. The black dashed line delineates the limit of the Long Valley caldera. The white arrows point to the two events shown in the bottom panels. The red box in the map inset indicates the study area within the United States. (B and C) Strain recorded by the DAS arrays induced by local events with NCEDC DD catalog IDs 73482516 and 73491170, respectively. The red and blue curves in these panels show the P—and S-wave neural-network-picked traveltimes on these two events, respectively. The green line indicates the portion of fiber that we interrogate. It is a single fiber that is employed. However, the cable is composed of multiple strands of fibers, most of which are used for telecom purposes.

FIG. 4. Local and regional events used in this study. Conventional stations are depicted by the blue triangles while the green line indicates the locations of the DAS channels. The earthquakes are indicated by the red dots whose sizes are proportional to their magnitude.

FIGS. 5A-5C. Assessing picking accuracy using event cross-correlations. (A) Crosscorrelation example between two events recorded by the South DAS array. The cyan line represents the cross-correlation-based shift retrieved by the multi-channel crosscorrelation algorithm. (B and C) Differential traveltime histograms for the P—and S-wave cross-correlation windows, respectively.

FIGS. 6A-6H. The Long Valley shear-wave anomalies. The panels on the left column display the initial model derived from surface-wave inversion, while the panels on the right depict the inverted S-wave velocity anomalies obtained by our tomographic DAS workflow. All perturbations are with respect to a one-dimensional Walker Lane crust profile (obtained by averaging the initial model along latitude and longitude). (A and B) Depth slices at −1.0 km elevation. The caldera and lakes' extents are shown by the black dashed lines. (C to H) Model profiles indicated in panel A. The white (panels A and B) and black (panels C to H) dashed lines delineate the −20% and −15% P-wave velocity contours. The white solid lines separating the shaded areas denote the resolvable model portions.

FIG. 7. Reference Walker Lane velocity profiles. P—and S-wave speed profiles employed to compute all the velocity perturbations shown in FIGS. 5 and S4.

FIGS. 8A-8D. The Long Valley V_{P}/V_{S} ratio structures. (A and C) V_{P}/V_{S} ratio derived from the initial wave-speed models for the cross-sections AA′ and BB′ in FIG. 3A. (B and D) Same as the previous panels but obtained from the final models. In all these panels, the red dots indicate the initial and relocated earthquakes within 10 km of the cross sections.

FIGS. 9A-9H. The Long Valley P-wave anomalies. The panels on the left column display the initial model structures, while the panels on the right depict the inverted P-wave velocity anomalies. All perturbations are with respect to a one-dimensional Walker Lane crust profile (obtained by averaging the initial model along latitude and longitude). (A to B) Depth slices at −1.0 km elevation. The caldera and lakes' extents are shown by the black dashed lines. (C to H) Model profiles indicated in panel A. The white (panels A and B) and black (panels C to H) dashed lines indicate the −15% and −12% P-wave velocity contours. The white solid lines separating the shaded areas denote the resolvable model portions.

FIGS. 10A-10G. Surface-wave dispersion curves from initial and inverted models. (A) Map showing the locations for which the surface-wave dispersion curves are computed. (B, D, and F) V_{P} (red lines) and V_{S} profiles of the initial (solid lines) and inverted (dashed line) models extracted at the corresponding points in panel A. (C, E, and G) Rayleigh dispersion curves for the corresponding panels on the left evaluated using the initial (solid green line) and inverted (dashed green lines) velocity profiles. The black vertical lines indicate the period range employed to construct the initial velocity models (i.e., 6 to 20 s periods ([0094])).

FIG. 11. Schematic model of the Long Valley magmatic system interpreted from the tomographic sections. The orientation of this interpretation is along the cross-section BB′ in FIG. 8D. The shallow formations are based on the geologic section in ([0078]). The location of the ash-rich sediments with a high V_{P}/V_{S} ratio and reduced wave speeds correlates well with the hydrothermal activity present in the eastern caldera area ([0074]). The boundaries of the Sierran basin follow the 1.74 V_{P}/V_{S} ratio bottom contour in FIG. 8D.

FIGS. 12A-12B. Resolvability test for an upper-crust low-velocity anomaly under the Long Valley caldera of 10 km radius. (A) Input synthetic V_{S} anomaly mimicking an uppercrust magma reservoir. (B) Velocity anomaly retrieved by our tomographic workflow. The black dashed lines in the velocity profiles indicate −15% and −20% velocity reductions.

FIGS. 13A-13B. Resolvability test for an upper-crust low-velocity anomaly under the Long Valley caldera of 5 km radius. (A) Input synthetic V_{S} anomaly mimicking an uppercrust magma reservoir. (B) Velocity anomaly retrieved by our tomographic workflow. The black dashed lines in the velocity profiles indicate −15% and −20% velocity reductions.

FIGS. 14A-14B Resolvability test for an upper-crust low-velocity anomaly under the Long Valley caldera of 2 km radius. (A) Input synthetic V_{S} anomaly mimicking an uppercrust magma reservoir. (B) Velocity anomaly retrieved by our tomographic workflow. The black dashed line in the velocity profiles indicates a −15% velocity reduction.

FIG. 15. Checkerboard test results for the V_{S} model. The size of each Gaussian anomaly is 10 km in each direction.

FIG. 16. Initial and final traveltime residual histograms. (A and B) Absolute traveltime residual histograms obtained using the initial P—and S-wave speed models. (C and D) Same as the top panels but obtained with traveltimes predicted using the inverted models.

FIGS. 17A-17B. Inverted wave-speed assessment with an independent event. (FIG. 17A) Map showing the location of the DAS array channels (black solid line) and of the event (red star) used for result validation. Recorded DAS strain of the event overlaid by the P-(red lines) and S-wave (blue lines) predicted arrival times using the initial (dashed lines) and inverted (solid lines) models (FIG. 17B).

FIGS. 18A-18H. Resolvability test for low velocities and high V_{P}/V_{S} anomaly under Mono Lake. (A-D) V_{S} decrease and V_{P}/V_{S} ratio anomaly introduced within our model to test the resolvability of the tomographic workflow underneath Mono Lake. A similar synthetic V_{P} reduction is placed under Mono Lake. (E-H) V_{S} reduction and V_{P}/V_{S} ratio anomaly retrieved by our method. The arrows point at the introduced and recovered anomaly in each panel. The black dashed lines in panels B and F indicate −15% and −20% velocity reductions.

FIG. 19. Example Hardware Environment.

FIG. 20. Example Network Environment.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized, and structural changes may be made without departing from the scope of the present invention.

### Technical Description

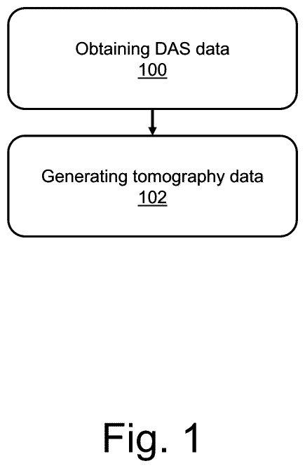

The present disclosure describes a computer-implemented method for performing seismic tomography, as illustrated in FIG. 1. The method comprises the following steps.

Block 100 represents obtaining, in a computer, seismic data including distributed acoustic sensing data measured using a network of optical fibers (e.g., telecommunication optical fibers) embedded in a geological structure. Example geological structures include, but are not limited to, the crust or a subsurface of the ground of the Earth, a planet, or other astrophysical object.

The seismic data can further comprise travel time data recorded from a plurality (e.g., at least 1000) of seismic events using a method different from DAS.

Example seismic events or sources include, but are not limited to, an earthquake, volcanic activity, an explosion from an active survey explosive source, a deformation of the ground caused by a hammer, or a deformation of the ground caused by a vehicle.

Block 102 represents performing tomography (e.g., travel time tomography) of the geological structure using the DAS data. In typical examples, the computer processes the DAS data to obtain tomographic data or to construct a map of seismic velocity structure or wave velocity as a function of position or location in the geological structure (e.g., along the trajectory between the seismic event and the measuring stations connected to the optical fibers). In various embodiments, velocity structure is the distribution and variation of seismic wave speeds within Earth's or other planetary bodies' subsurface.

In various examples, the tomographic map is of at least one of a geothermal anomaly (temperature variation as a function of position), faults or anomalies in a fault structure, a magmatic system, an oil field, a natural gas field, a composition of the geological structure, or a geophysical structure (type of layer structure and/or materials in the subsurface).

In various examples, the tomographic map is of sufficient resolution and quality to be used for geothermal prospect exploration, subsurface monitoring for carbon sequestration, characterization of subsurface properties for earthquake amplification factor estimation, earthquake prediction, detection or alarm systems, or volcanic eruption detection, prediction or alarm systems.

In various examples, the tomographic data is generated with an accuracy wherein the tomographic map has a spatial resolution of less than 10 km or less than 1 km.

In various examples, the seismic events are located within 200 km of the network of fibers and the tomographic data generates a map of an area enclosing the network of optical fibers and extending no more than 10 km from a furthest extremity of the network of fibers.

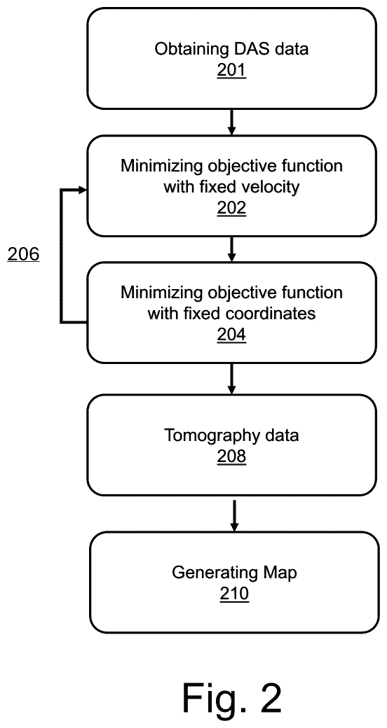

FIG. 2 illustrates an embodiment of the method for performing seismic tomography by minimizing objective functions, comprising the following steps.

Block 200 represents obtaining seismic data generated by a seismic source of P and S waves in the geological structure. In one or more embodiments, the step comprises obtaining a first set of P-wave and S-wave travel times from over a thousand seismic events to a plurality of recording stations; and obtaining a second set of P-wave and S-wave travel times from a subset of the seismic events and measured using distributed acoustic sensing. In various embodiments, the second set of travel times are picked using a machine learning model and have a signal to noise ratio above a threshold value. In one or more examples, the machine learning picks backscattering peaks from two different seismic events, and compares them to determine accuracy, e.g., by cross correlation. In this way, data from stronger (more powerful) seismic events can be selected because travel times from these events can be fitted during the optimization process with higher confidence and accuracy. Further information on using machine learning to pick arrival times can be found in U.S. patent application Ser. No. 18/435,876 entitled “Seismic Arrival-Time Picking on Distributed Acoustic Sensing (DAS) Using Semi-Supervised Learning,” which application is incorporated by reference herein.

Block 202 represents minimizing an objective function of the travel times, a model for propagation of the waves, and a fixed velocity structure of the waves, to obtain coordinates (e.g., spatial and/or temporal coordinates, or relocation) of the seismic events/sources. The minimizing comprises an iterative process (e.g., gradient based optimization) wherein the spatial and/or temporal coordinates are changed/updated in the model in each iterative step (using the fixed/same velocity structure), until the coordinates provide an optimal fit (to within a predetermined accuracy) of the travel times. The iteration can be performed to fit all the seismic data or only the subset of DAS data having the higher signal to noise. Thus, for the coordinates that provide the optimal fit, or best match, the objective function is minimized.

In one embodiment the following objective function is minimized.

$$ϕ ( {x}_{s} ) = \frac{1}{2} {‖ [ \begin{matrix}{λ}_{A} I \\ {λ}_{DD} D\end{matrix} ] [ {f}_{v} ( {x}_{s} ) + {τ}_{0} - {τ}_{obs} ] ‖}_{2}^{2} + \frac{ϵ}{2} {‖ {x}_{s} - {x}_{s , 0} ‖}_{2}^{2} \qquad ( 1 )$$

where λ_{A} and λ_{DD} are the relative weights of the absolute and double-difference traveltime errors ([0113]), respectively, τ_{obs} are the observed P—and S-wave traveltimes, ƒᵥ is the Eikonal operator for fixed velocity structures v in which reciprocity is employed

xₛ represents the earthquake locations and τ₀ their origin times, and D is the double-difference operator ([0120]), which represents a matrix of size M×N(M, number of double-difference observations; N, number of events). In one or more embodiments, this operator contains the following weighting term:

$${W}_{ij} = {max}^{a} [ 0 , 1 - {( \frac{{s}_{ij}}{c} )}^{b} ] \qquad ( 2 )$$

where sᵢⱼ is the interevent distance between the i-th and j-th events, c is a cutoff value to dismiss measurements of event pairs with an interevent distance larger than its value, and a and b are exponents that define the shape of the weighting curve. In our workflow, we set a, b, and c to 1.0, 1.0, and 5.0 km, respectively. In one or more embodiments, the regularization term based on the initial earthquake locations x_{s,0} and weight by the scalar e is necessary to avoid inversion instabilities when λ_{A}=0 ([0120]). This regularization term is necessary at the last relocation step when the velocity structures and current event locations are assumed to be close to their correct values. In other cases, we set ϵ=0. For each event, the optimal origin time is found at the beginning and at the end of the relocation process with the following equation:

$${τ}_{0}^{j} = \frac{1}{{N}_{r}} {\sum }_{k = 1}^{{N}_{r}} [ {τ}_{obs}^{j , k} - {f}_{v}^{j , k} ( {x}_{s} ) ] \qquad ( 3 )$$

where optimal origin time for the j-th event is simply the average of the traveltime residuals over the picked Nᵣ stations.

Block 204 represents minimizing the objective function of the travel times, the model, and the coordinates providing the best fit in Block 202, to obtain the velocity structure of the waves generated at the seismic event/sources. The minimizing comprises an iterative process (e.g., gradient based optimization) wherein the velocity structure is changed/updated in the model in each iterative step (using the fixed/same coordinates outputted from Block 202), until the velocity structures provide an optimal fit (to within a predetermined accuracy) of the travel times. The iteration can be performed to fit all the seismic data or only the subset of DAS data having the higher signal to noise. Thus, for the velocity structure that provides the optimal fit, or best match, the objective function is minimized.

In one or more embodiments, the velocity models are obtained by minimizing the following cost function:

$$ψ ( v ) = \frac{1}{2} {‖ [ \begin{matrix}{λ}_{A} I \\ {λ}_{DD} D\end{matrix} ] [ {f}_{{x}_{s}} ( v ) + {τ}_{0} - {τ}_{obs} ] ‖}_{2}^{2} \qquad ( 4 )$$

where ƒₓ_{ₛ} is the Eikonal operator for fixed event locations xₛ. The operators ƒ solve the following Eikonal equation

$$∇ τ = \frac{1}{{v}^{2}} subject to τ ( {x}_{■} ) = 0 \qquad ( 5 )$$

where x_{▪} represents the event or receiver locations for ƒₓ_{ₛ} and ƒᵥ, respectively. Smoothness in the model can be imposed by applying a Gaussian filter to the computed gradient during the optimization process.

Block 206 represents iteratively repeating the steps of Blocks 202 and 204, using the final velocity structure providing the best fit from Block 204 as the fixed velocity structure in a next iteration of Block 202, until the coordinates and the velocity structure have sufficiently converged (i.e., do not change by more than a predetermined amount, e.g., 1% as compared to their respective values in the previous iteration).

In one or more embodiments, the BFGS ([0121]) iterative scheme is used to minimize both objective functions (Blocks 202 and 204).

Block 208 represents outputting the tomography data comprising the converged velocity structure after the completion of the iteration in Block 206.

Block 210 represents optionally generating and/or displaying a tomographic map of the velocity structure as a function of the coordinates and a 3D location in the geological structure.

### Example Implementation

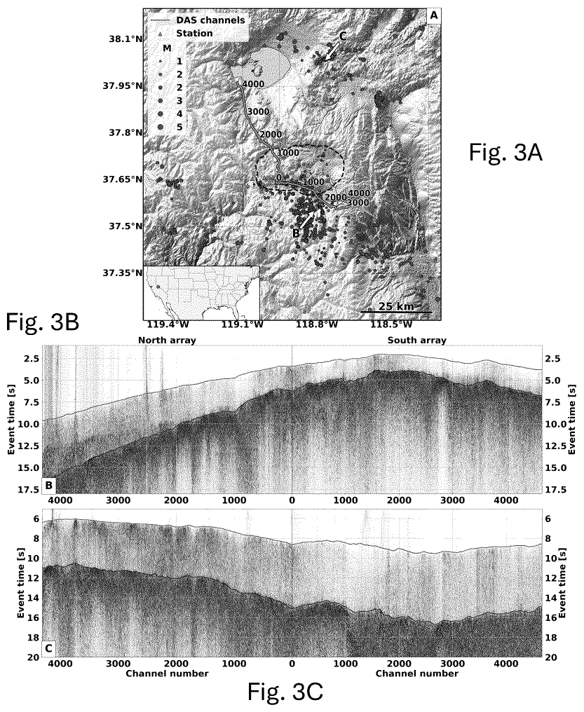

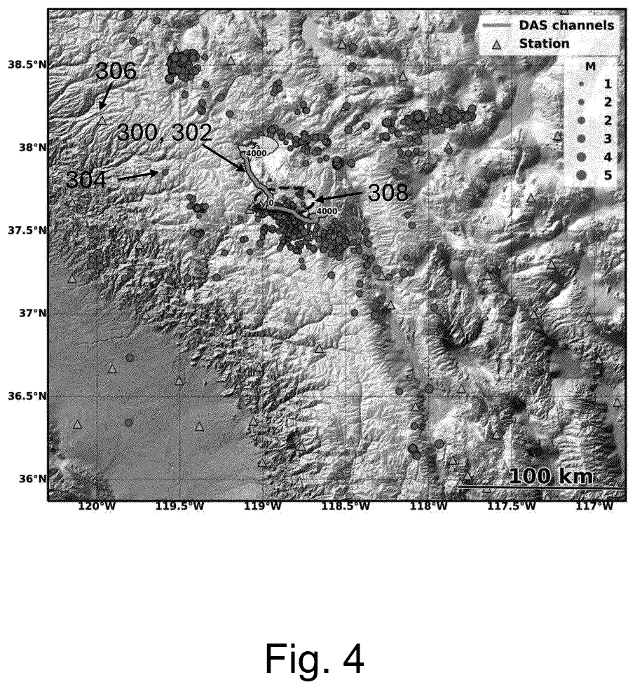

Recent tomographic studies of the Long Valley caldera highlighted the presence of a large magmatic body in the middle crust but were limited by the scale and resolution of the seismic arrays employed to form the tomographic images ([0077], [0083]-[0086]). In this study, we employed two distributed acoustic sensing (DAS) units to record seismic data along telecommunication fiber-optic cables (FIGS. 3 and 4). DAS deployed on fiber-optic cables was used to record earthquakes and other seismic signals with unprecedented temporal and spatial resolution ([0087], [0088]); especially, in volcanic areas ([0089]-[0091]). Our two DAS arrays were composed of more than 9000 channels covering an approximately 100-km north-south transect across the caldera, with precise channel locations obtained using a vehicle-based positioning method ([0092]). The total aperture and channel density of the DAS arrays enabled the imaging of subsurface structures that could not be resolved by previous studies that only relied on conventional networks.

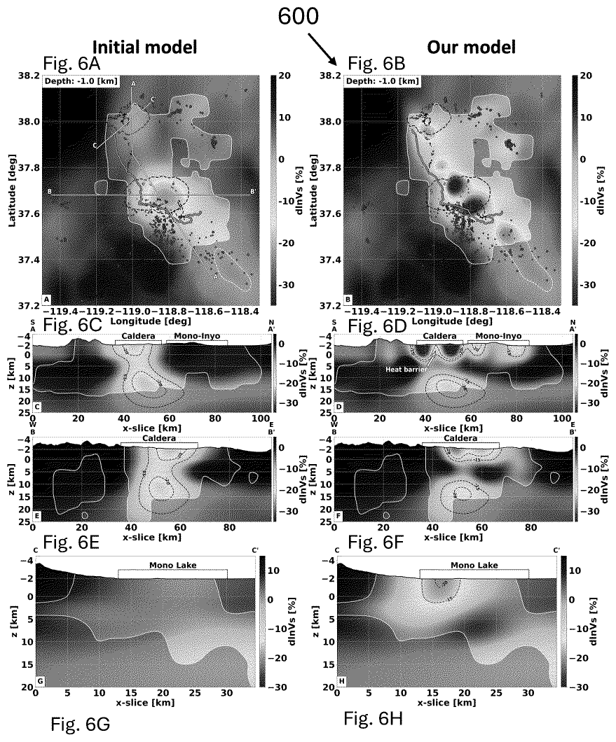

Over a 12-month period, we detected more than 6000 local and regional earthquakes that were also cataloged by the Northern California Earthquake Data Center (NCEDC) ([0093]). We trained a deep neural network model to accurately pick more than 12 million P—and S-wave arrival times and incorporate these measurements within an efficient tomographic workflow. DAS provides a total number of traveltime measurements that is 2 to 3 orders of magnitude larger than conventional, even dense, seismic arrays, which represents a computational challenge for existing tomographic approaches. Moreover, volcanic areas present subsurface structures with significant velocity contrasts resulting in complex seismic raypaths. Complex ray geometries and handling the large number of traveltime measurements were accounted for using the double-difference (DD) Eikonal traveltime tomography workflow based on the adjoint-state method described above with reference to FIG. 6. The nonlinear iterative nature of the method correctly modeled ray bending, while the matrix-free formulation permitted the efficient inversion of billions of DD traveltimes.

### 1. First Step: Picking P—and S-Wave Arrivals on DAS Data Using Machine Learning

FIG. 4 depicts the local and regional seismicity employed within this study including a total of 2173 events (red dots in FIG. 4) from the double-difference (DD) catalog of the Northern California Earthquake Data Center (NCEDC) ([0093]). These earthquakes were recorded by both conventional stations (blue triangles in FIG. 3) and distributed acoustic sensing (DAS) arrays (green lines in the same figure) and occurred between November 2020 and November 2021. The minimum magnitude considered was 0.1 while the maximum is 4.96. From these events, we selected 843 earthquakes with an average signal-noise ratio (SNR) equal to or above 40 dB on the DAS data (examples of the selected events are shown in FIG. 3). We estimated the SNR of each event by computing the noise and signal energy using 2-second and 0.8-second windows before and after the initially predicted P-wave traveltime, respectively. We obtained the necessary P—and S-wave observed traveltimes by employing a neural network model designed to accurately pick DAS data called PhaseNet-DAS ([0109]). This model is based upon PhaseNet ([0110]), which is a modified U-Net architecture ([0111]) with 1D convolutional layers for processing 1D time series of seismic waveforms. We extended this model using 2D convolutional layers to fully exploit both spatial and temporal information of 2D DAS data.

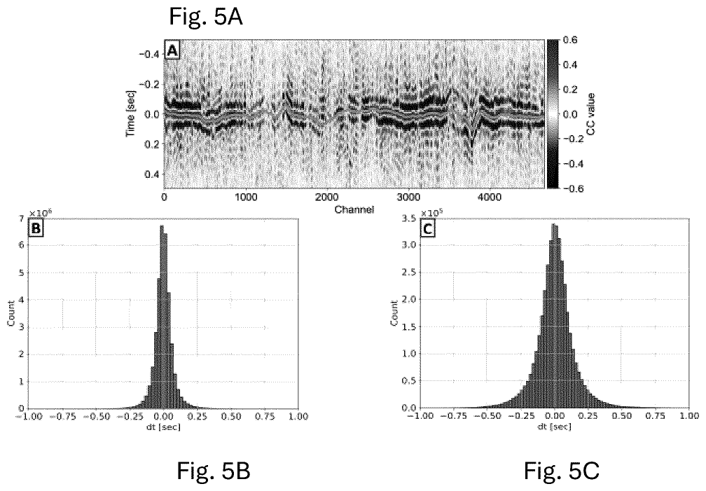

PhaseNet-DAS obtains accurate traveltime picks when high-SNR DAS data are fed into the neural network. The panels B and C in FIG. 3 show two representative events overlaid with the P—and S-wave picked traveltimes. Both curves closely follow the P—and S-wave onsets clearly observable in these two panels. All the other events present a similar behavior in terms of onset-traveltime matching quality. We also quantitatively estimated the picking accuracy using a cross-correlation methodology. We cut a 4-second window around the arrivals obtained by PhaseNet-DAS, apply a band-pass filter between 1 Hz-10 Hz, and calculate the cross-correlation between event pairs. We estimated the differential time by picking the peaks within the cross-correlation profiles for each channel. To further improve the accuracy of the differential traveltime measurements, we employed a multi-channel cross-correlation strategy ([0112], [0113]) to extract the peaks across multiple cross-correlation profiles. For our analysis, we chose event pairs whose average cross-correlation coefficients are higher than 0.4 for P-wave and 0.6 for S-wave. This choice allows us to retrieve 34, 193,571 P-wave and 3,944,318 S-wave differential traveltime measurements from 7583 (FIG. 5A) and 1095 event pairs, respectively. The histograms of these differential traveltime values are shown in FIGS. 5B and 5C. If we assume Gaussian distributed traveltime picking errors, the differential time measurements obtained by waveform cross-correlation can be used to estimate the error distribution. The differential traveltime measurements have a mean of −1 ms and a standard deviation of 70 ms for P waves and a mean of 3 ms and a standard deviation of 140 ms for S waves. These values correspond to standard deviations of 49.5 ms and 99 ms for P—and S-wave picking errors made by the PhaseNet-DAS model, respectively. For comparison, the absolute arrival-time errors of the PhaseNet architecture compared with manual picks on conventional stations have a mean of 2.1 ms and a standard deviation of 51.5 ms for P waves, and a mean of 3.3 ms and a standard deviation of 82.9 ms for S waves ([0110]).

### 2. Second Step: Double-Difference Eikonal Relocation and Tomography

The DD Eikonal traveltime relocation and tomography workflow based on well-established inversion packages ([0114]) applied to the method of FIG. 2 and equations 1-5 was utilized. Compared to conventional methodologies, the inversion scheme was matrix-free and based on non-linear optimization iterative schemes. We computed the necessary objective function gradients using the adjoint-state method applied to the Eikonal equation ([0115]-[0117]). By not storing and inverting any matrix during the optimization process, we were able to invert traveltime picks obtained on the thousands of channels composing the DAS arrays used in this study. Within a DD framework, the size of the considered least-squares matrices would be on the order of billions of elements, which even with modern computational architectures would be impossible to invert within a reasonable time. The workflow using an operator-based optimization approach ([0118]) as describe above enabled us to overcome these limitations. As discussed above, to mitigate the location and velocity structure trade-off, we performed the traveltime inversion in an alternate-direction fashion ([0117]): we first relocated the events for fixed P—and S-wave velocity structures (Block 202), then we fixed the earthquake locations and inverted the P—and S-wave models (Block 204). These two steps were alternated (Block 206) until convergence was reached based on locations and velocity model changes.

In this study, event relocation is achieved using P—and S-wave traveltimes obtained using PhaseNet ([0110]) applied to 80 three-component stations for the 2173 events shown in FIG. 4, while the tomography step is conducted using the traveltimes from the 843 picked by PhaseNet-DAS. We performed the tomography step for P—and S-wave models independently; thus, the obtained structures in each wave-speed model are inferred by independent data information. The Gaussian smoothing width is based on the results of checkerboard tests conducted at different scales and we set its standard deviation to 5 km. At the beginning of the inversion process, a higher weight to the absolute traveltime residuals is imposed, and as the workflow progresses the relative double-difference residuals are weighted with higher values ([0114]).

### 3. Results

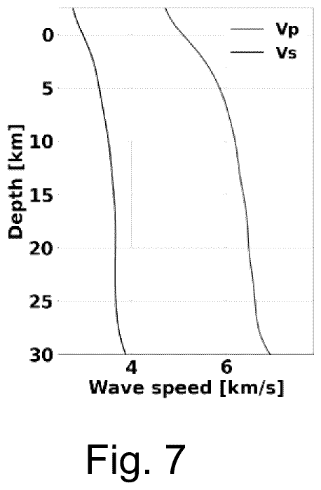

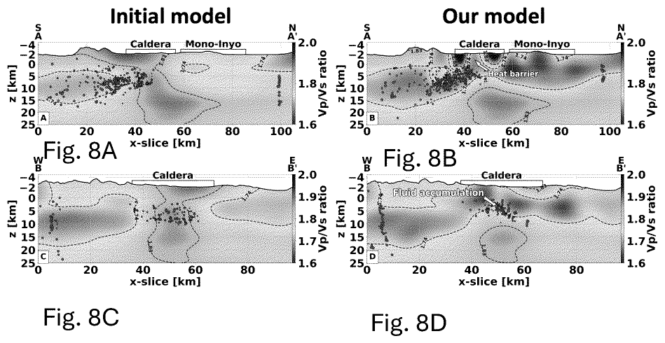

FIG. 6 shows our tomographic images of the Long Valley caldera, in a side-by-side comparison with the latest tomography P-(V_{P}) and S-wave velocity (V_{S}) model, which is also our initial model, based on full waveform inversion of surface waves between 6 and 20 s ([0094]). All plots are shown as perturbations with respect to an average one-dimensional Walker Lane crust profile (FIG. 7). With the improved data coverage from the two DAS arrays, we substantially improved the model resolution in the top 15 km to 20 km. The heterogeneous shallow structures within the caldera, which only appear as a smooth low-velocity anomaly in the initial model, become sharp in our new tomographic model and correlate well with surface geology. These shallow velocity reductions are likely related to the filling material (e.g., volcanic ashes, alluvial) deposited in the depression and the extensive surface hydrothermal system ([0074],) This hypothesis is corroborated by the high V_{P}/V_{S} ratio measured (greater than 1.8) within these anomalies, commonly associated with highly fractured and fluid-permeated rocks ([0096]) (FIG. 8). The shallow higher velocity and low V_{P}/V_{S} ratio barrier separating the two anomalies, visible in the cross-section AA′ (see white arrows in FIGS. 6D and 8B), has been also observed by other local tomography studies ([0084],), and could be composed of less fractured crystalline rocks compared to the surrounding units. This structure would explain the low temperature measured at the bottom (approximately 2.5 km depth from the surface) of the Long Valley Exploration Well ([0097]), which could inhibit the transfer of heat via convective movement of magmatic volatiles by restricting fluid motion.

### (i) Tomography of the Mono-Inyo Craters Structures

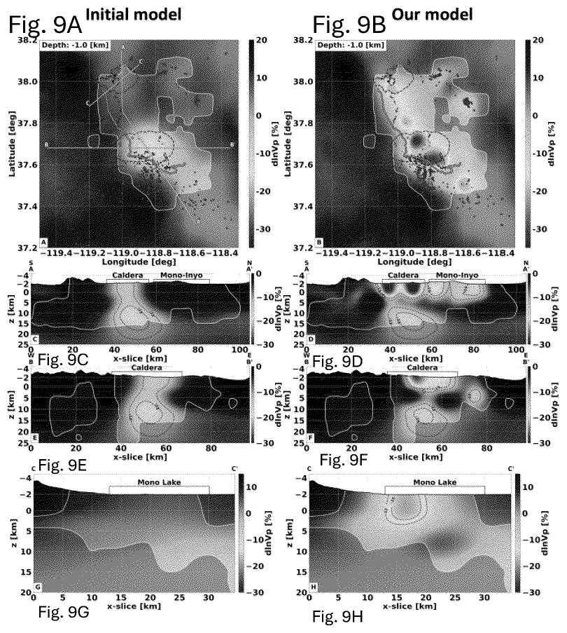

With the DAS arrays extending approximately 30 km north of the caldera rim, our tomography closes the gap in knowledge of upper crustal structures across the broader Long Valley magmatic system. North of the caldera region lies the Mono-Inyo Craters, a north-south trend of lava domes and volcanic craters. These craters are the youngest geological features in the Long Valley area, ranging in age from 40,000 to only 250 years ago ([0098]). Previous studies have highlighted the existence of gravity and resistivity anomalies that have been interpreted as part of the hydrothermal network of this portion of the volcanic field ([0099], [0100]). However, seismic surveys were not able to provide evidence of any velocity variations due to the sparsity of station coverage outside the caldera ([0086]). Our model is in good agreement with the resistivity and gravity observations, revealing seismic velocity anomalies associated with these upper-crustal structures (AA′ cross-section, FIGS. 6D and 9D). A basin-oriented north-south low-velocity anomaly is evident below the Mono-Inyo craters, the depth of which reaches approximately 4 km below sea level. Moreover, two reductions in seismic velocity are located within the Mono basin, with one centered below Mono Lake where the most recent volcanic eruptions in the Long Valley region occurred around 250 years ago ([0056]) (CC′ cross-section, FIGS. 6H and 9H). These two anomalies could be again linked with shallow hydrothermal systems given their relatively high V_{P}/V_{S} ratio (approximately 1.8). The depth sensitivity of our tomography is not able to resolve the small intruded magmatic bodies that likely formed these volcanic centers ([0083]). However, no conduit is evident connecting these structures to a deeper magmatic source, supporting their currently hydrothermal nature.

### (ii) Tomography of the Long Valley Volcanic Upper-Crust Lid

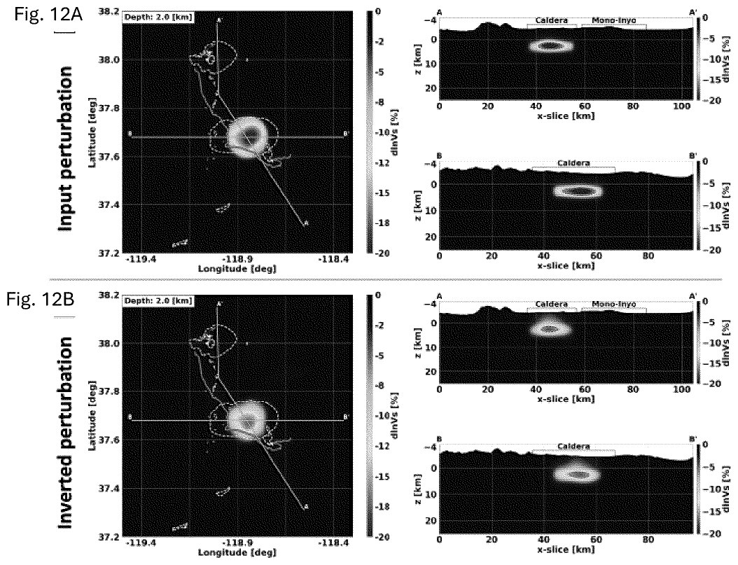

In the cross-sectional views of Long Valley Caldera, we observe a clear separation between the large magma body at depth and the upper-crustal low-velocity structures (FIGS. 6 and 9). The initial V_{P} and V_{S} models suggested the existence of an approximately 10-15-km wide conduit connecting the deep magma chamber to the shallow crust. This apparent connectivity in previous models is an artifact of the limited depth resolution of surface-wave inversion methods ([0101]). In our images, the structure separating the upper and mid-crustal depths is likely the remnant of the roof block that collapsed as part of the caldera-forming 760 ka eruption. The top interface of the magmatic chamber, located at approximately 8 km depth from the mean sea level, is in agreement with previous depth estimates from reflection studies ([0102]-[0104]). Furthermore, the crustal block above the magmatic chamber presents a typical crustal V_{P}/V_{S} value (approximately 1.7), indicating that the magma body at depth is disconnected from the shallower low-velocity structures of the hydrothermal system throughout the caldera (FIGS. 8B and 8D). The lower boundary of this structure represents the transition between brittle to ductile rock behavior as suggested by the concentration of the seismicity mostly confined in this layer (FIGS. 8B and 8D), whose lower limit varies from 10-15 km depth outside of the caldera to 5 km depth at the center of Long Valley. The west-east section of FIG. 8D reveals the thinning of this layer at about 50 km along the section beneath the resurgent dome at the center of the caldera, with a concentration of seismicity at 4 km depth. The extent and position of this structure correlate well with the geodetic source of recent uplift ([0105]). These findings exclude the possibility of shallow intruded magma bodies larger than 2 km and support the interpretation of deformation driven by the accumulation of exsolved fluids at the center of the caldera that permeate the preexisting southern moat and ring faults, driving the observed seismicity. This interpretation is corroborated by the hypothesis-driven tests of FIGS. 12-14 in which any upper-crust velocity reduction larger than 2 km in size can be correctly detected and estimated.

### 4. Key Improvements in Crustal Imaging

The spatial extent and channel density of our DAS arrays overcome the inherent limitations associated with conventional broadband networks often utilized in body-wave tomography ([0058]). Leveraging the DAS high-spatial sampling capabilities, we attain exceptional lateral resolution in shallow depths (0-8 km), while the wide aperture of our arrays enables us to image the middle and lower portions of the subsurface (8-30 km) with a remarkable level of detail. Our findings exhibit resemblances to earlier studies ([0084], [0085]), such as the high-velocity barrier at the center of the resurgent dome (FIG. 6D) and the low velocity and high V_{P}/V_{S} ratio shallow anomalies associated with the hydrothermal caldera system (FIGS. 6B, 6D, and 8B). However, thanks to the aforementioned advantages, we enhance the current understanding by presenting a comprehensive picture of the entire volcanic system, which was missing from previous tomographic results.

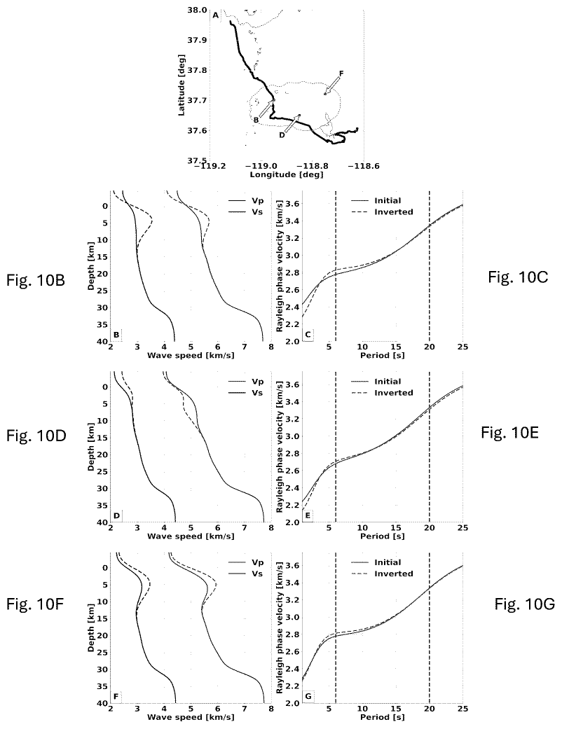

Similarly, surface-wave inversion strategies can resolve large-scale velocity anomalies but lack the lateral resolution to delineate near-surface structures due to the commonly considered wave periods and station coverage ([0097]). This limitation can be verified by comparing surface-wave dispersion curves obtained using the initial and inverted models. To this end, we extracted three velocity profiles from locations placed within the caldera area (FIG. 10A) and compute the Rayleigh phase-velocity dispersion curves ([0106]). The necessary density profiles are obtained using an empirical relationship calibrated on crustal rocks ([0107]). The left panels in FIG. 10 depict the V_{P} (red lines) and V_{S} profiles of the initial (solid lines) and inverted (dashed line). The corresponding surface-wave dispersion curves are shown on the right panels in FIG. 10. The black dashed vertical lines bound the range of periods that were used to obtain the initial velocity models. When comparing the dispersion curves from the initial (solid green lines) and the final dashed green lines) models, only minor differences can be observed, and even at shorter periods than 5 s down to 1 s, the two curves do not present substantial phase velocity differences. This comparison highlights the consistency of the inverted wave speeds in preserving the surface-wave structures and the inability of surface-wave inversion methodologies to refine the near-surface structures due to an intrinsic non-uniqueness of the inverse problem for the considered periods.

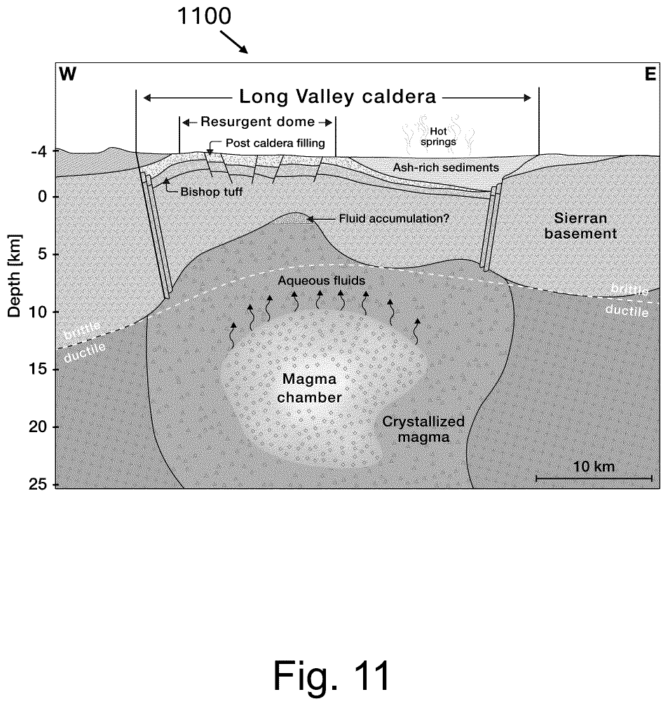

Our results allow the generation of a structural map illustrating the fluid-driven nature of the uplift and unrest occurring in the Long Valley Caldera and represent the first tomographic evidence supporting the second-boiling hypothesis with a lack of recent upper crustal intrusions. FIG. 11 shows a schematic model based on the structures highlighted in the BB′ cross-section. The resurgent dome presents lower V_{P}/V_{S} and higher velocities than the surrounding region, as observed by previous studies ([0084],) The higher V_{P}/V_{S} values and lower velocities in the eastern portion of the caldera correlate well with the location of hot springs and ash-rich sediments. In our interpretation, the Sierran basement, which was part of the pre-caldera magmatic roof block, covers the contemporary magma chamber and isolates the magma body from the shallow crust. Our new observations place tighter constraints on the melt region, which exhibits an overall V_{S} anomaly of −15% and a total volume of 6,400 km³, which is in the same order of magnitude as other large volcanic systems (5-7). By using experimental melt-fraction curves ([0086]), the melt fraction varies from 21% to 23% and corresponds to a total storage of 1,350 km³ of melt, which agrees with previous estimates ([0086]). Within sill-like structures, inferred from the estimated seismic anisotropy in this volcanic system ([0108]), the melt fraction might be slightly underestimated compared to the one obtained from the average inverted V_{S} values. Such melt-fraction values are not close to the critical porosity of a magmatic mush (approximately 40% ([0058])) required to induce the mobilization of magma towards the surface. Thus, the retrieved velocity anomalies suggest a current textural equilibrium (as a distributed melt or as small melt-rich pockets) of the crystal mush, which implies the stagnation and crystallization of the mid-crustal chamber associated with subsequent exsolution of fluids. Fluids released from the apex of the crystallizing chamber are then trapped at the bottom of the Sierran basement providing the pressure source of the observed uplift. Finally, the accumulated fluids migrate laterally toward the southern segment of the ring-fault zone and drive the south-moat observed seismicity. This interpretation does not preclude the possibility of new mantle injections that would perturb the textural equilibrium of the magma chamber, which could result in the revitalization of this moribund volcanic system.

### 6. Additional Characterization Metrics

### Checkerboard Test and Model Resolvability

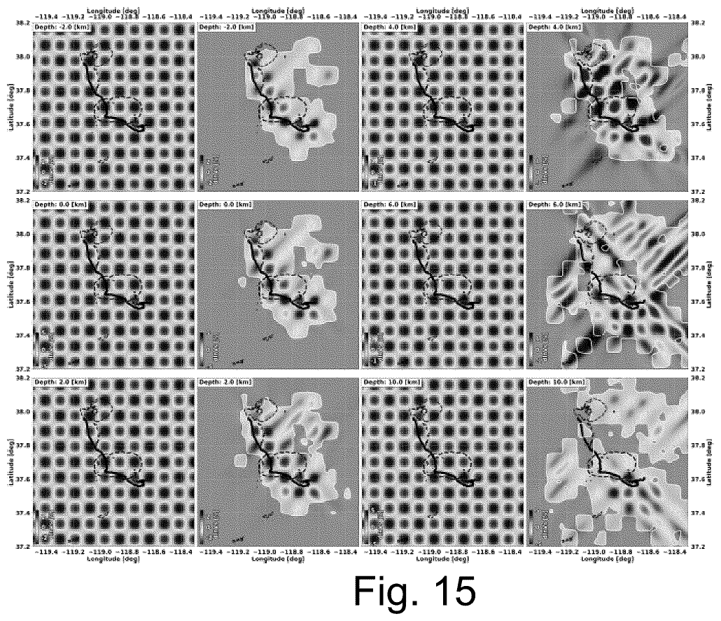

We conducted conventional seismic tomography checkerboard tests in which oscillatory anomalies of −5% and 5% variations in the P-(V_{P}) and S-wave (V_{S}) speeds are introduced within the initial models (40,68). Based on the estimated picking errors, we introduce zero-mean Gaussian noise to the model traveltimes whose standard deviations are 50 ms and 100 ms to the P—and S-wave picks, respectively. We also randomly perturb the event locations by +500 m in each direction. The panels in FIG. 15 show the true and retrieved perturbations at various depth levels for the inverted V_{S}. To indicate the portions of the models that are resolvable by the tomography approach, we employ the resolvability index (5,69,70). This index ranges from 0 to 1:0.5 represents portions of the model for which 0% of the perturbation is retrieved (i.e., zero sensitivity), a value of 1 is a perfect reconstruction, and 0 defines portions for which −100% of the perturbation is inverted. The shaded areas in these panels indicate a resolvability index smaller than 0.6, which is considered a reasonable lower bound for resolvable areas (5,70). Similar results are obtained for the V_{P} perturbations. The best resolution (i.e., no smearing effect) is obtained in the proximity of the DAS channels for most of the depth slices. For the shallow slices (−2 to 2 depths), almost no smearing is observed in the proximity to the sensed fibers. Deeper slices present a broader area of resolvability but at the cost of smearing the perturbations. Below 15 km depth, a significantly reduced portion of the subsurface is resolvable due to the limited number of rays reaching that portion of the model.

### P-Wave Velocity Anomalies, Residual Histograms, and Velocity-Model Validation

FIG. 9 displays the same slices of FIG. 6 but for the V_{P} anomalies from a one dimensional Walker Lane crust velocity model shown in FIG. 7. This one-dimensional model is obtained by averaging the initial model along the latitude and longitude axes. Compared to the initial model shown in the panels on the left column, the inverted velocity anomalies (right column) present the same clear separation between the magmatic chamber centered at approximately 12.5 km depth and the shallow structures above as in the S-wave anomalies. Additionally, similarly to the V_{S} model, velocity reductions within the caldera, along the Mono-Inyo craters, and underneath the Mono lake are obtained by the tomographic workflow. Similar features are obtained from the tomographic workflow when using this 1D model as an initial guess. However, these anomalies are better defined by starting the tomographic process from the surface-wave inverted velocities. In addition, the 3D surface-wave derived model as an initial guess provides lower final traveltime residuals compared to the 1D model when used to start the tomography workflow.

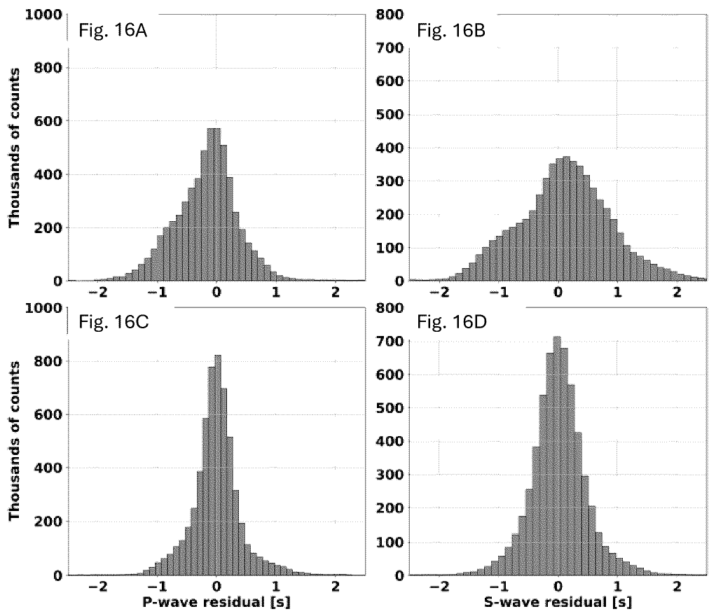

The top panels in FIG. 16 show the P—and S-wave absolute traveltime residual histograms obtained using the initial velocity models (FIGS. 16A and B, respectively). Their respective residual means are −0.17 s and 0.11 s, while their standard deviations are 0.65 s and 0.78 s. The relocation and tomography workflow produces velocity models whose traveltime residuals are Gaussian distributed with means of −0.01 and 0.01 and standard deviations of 0.4 s and 0.47 s for P—and S-wave traveltimes, respectively (FIG. 16C and D). Tighter distributions could be achieved by relaxing the smoothness constraints defined by the Gaussian filter employed during the inversion process.

However, smaller-scale velocity anomalies are not resolvable by the event-channel geometry (based on checkerboard test analyses) and thus we avoid introducing them during the inversion process.

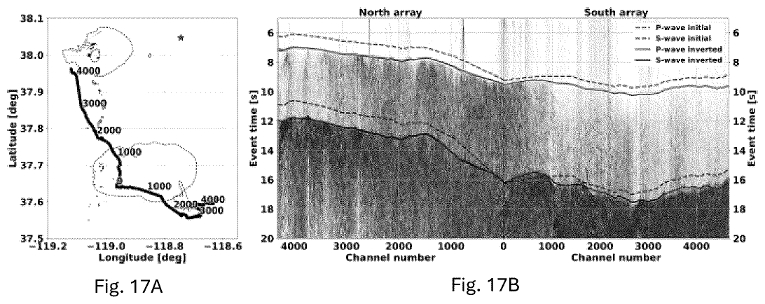

Finally, we validate our inverted velocities by modeling the arrival times for a relocated event that was not included during the tomographic steps. The event ID from the NCEDC DD catalog is 73485976 and its magnitude and relocated depth are 2.8 and 2.327 km, respectively. The maximum and minimum distances from the DAS channels are 33.5 km and 54.5 km (FIG. 17). FIG. 17 displays the recorded DAS data in which we overlay the P-(red lines) and S-wave (blue lines) traveltimes predicted from the initial (dashed lines) and inverted (solid lines) velocity models. The final velocities predict traveltimes closely following the observed arrival onsets. On the other hand, the initial models underestimate the observed onsets, highlighting the presence of low-velocity anomalies (e.g., MonoInyo crater basin) necessary to obtain correct traveltime predictions.

Our melt fraction estimations are based on a linearized V_{S}/melt-fraction derivative (δV_{S}/δMF) of −23 m/s/MF derived by averaging the Voigt and Reuss V_{S}/melt-fraction trends for a 4% H₂O—wet rhyolite at 310 MPa and 750° C. (27). In our models, the −15% and −20% S-wave reductions within the magma chamber correspond to wave speeds of 3.0 km/s and 2.86 km/s with V_{P}/V_{S} of 1.83 and 1.86.

### Hypothesis-Driven Resolution Tests

To test the resolution and bias of our workflow in imaging known seismic anomalies, we invert synthetic traveltime datasets where different type of velocity reductions. As in other tomographic studies (5,32), when displaying the results of our synthetic tests, we show the input and inverted anomalies with the background model removed to better highlight the resolved portion of the introduced perturbation.

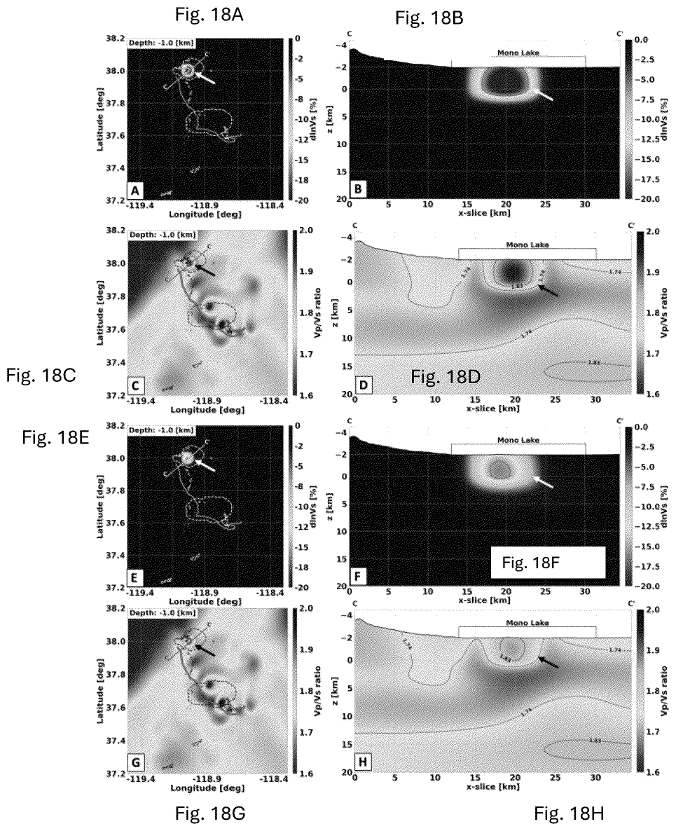

In our first resolvability test, we introduce a low V_{P} and V_{S} anomaly underneath Mono Lake with a high V_{P}/V_{S} to simulate the presence of a large water saturated materials (FIG. 18A-D). We apply the same procedure as described for the checkerboard test to invert the synthetic traveltimes. Our tomographic workflow can correctly retrieve the shape and the overall velocity decrease as well as V_{P}/V_{S} ratio with a minor underestimation of both properties (FIGS. 17E-H).

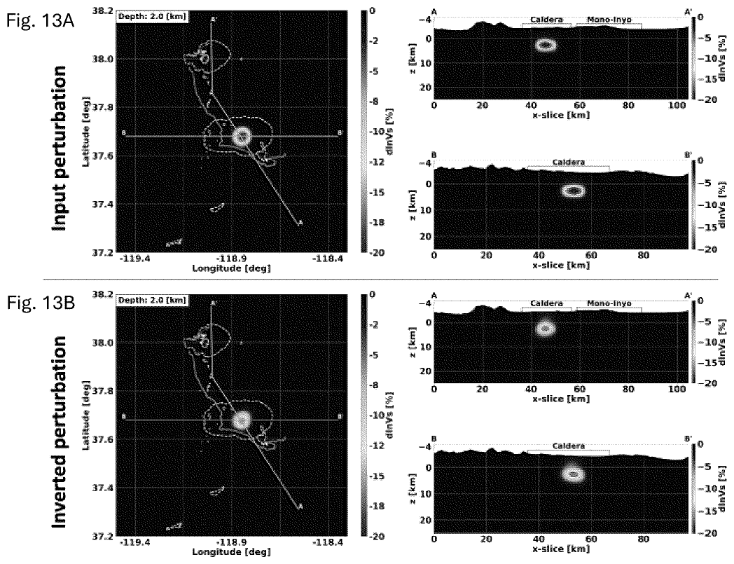

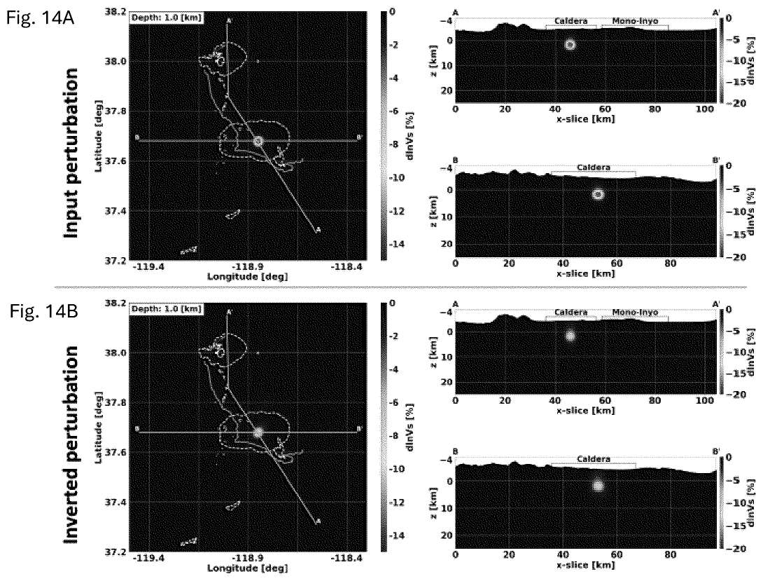

In our second set of simulated experiments (FIGS. 12, 13, and 18), we incorporate a sequence of lowshear-wave velocity reductions that progressively diminish in size. The goal is to evaluate the resolution limits of our method in imaging upper-crust magma reservoirs, which are not present within our results obtained using our DAS dataset. In each test we introduce a cylinder-shaped anomaly, a large perturbation of 10 km radius and 4 km thickness (FIG. 12), a middle-size reservoir of 5 km radius and 4 km thickness (FIG. 13), and a small 2 km radius and 2 km thickness anomaly (FIG. 14). In all three cases the shape of the anomalies is well-imaged by our tomographic approach with an underestimation of the velocity decrease within the center of the anomaly; especially, for the smallest anomaly of 2 km radius. If the large and middle-size reservoirs were present within our results, we would have clearly detected and interpreted them as potential upper-crust magma reservoirs. On the contrary, the smallest anomaly is close to the resolution limits of the method given the employed DAS geometry and earthquake locations. Thus, any small upper-crust reservoirs whose core has a size less than 2 km in diameter may be challenging to detect due to the underestimation of the velocity reduction, although improved resolution could achieved with different DAS geometry.

### Hardware Environment

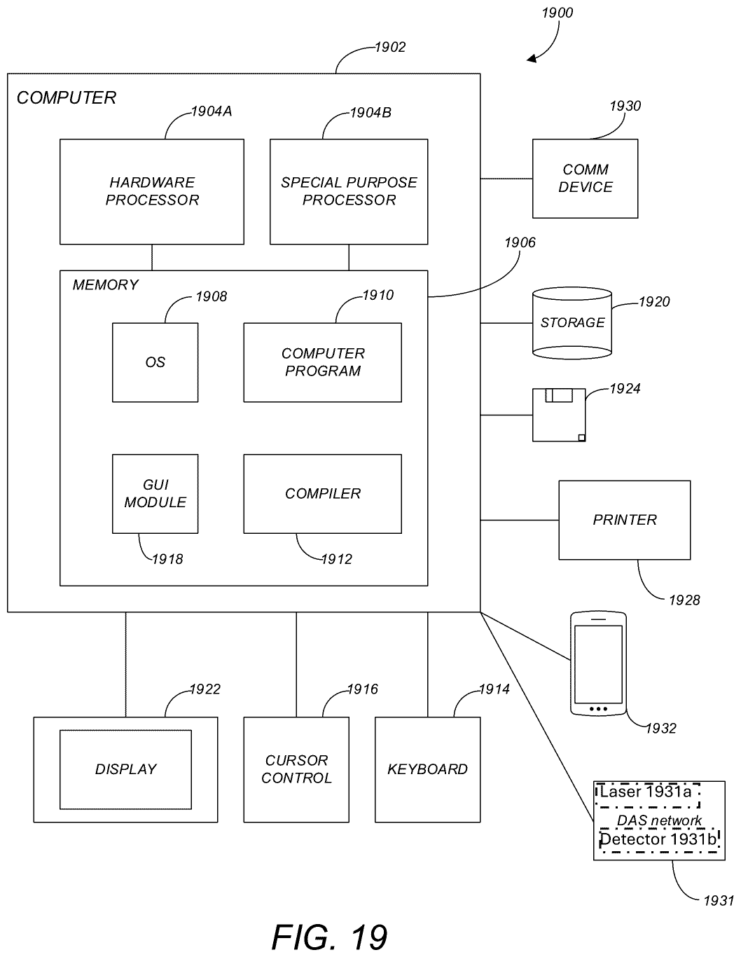

FIG. 19 is an exemplary hardware and software environment 1900 (referred to as a computer-implemented system and/or computer-implemented method) used to implement one or more embodiments of the invention by connection to a DAS network comprising optical fibers coupled to DAS recording stations 1931. The hardware and software environment includes a computer 1902 and may include peripherals. Computer 1902 may be a user/client computer, server computer, or may be a database computer. The computer 1902 comprises a hardware processor 1904A and/or a special purpose hardware processor 1904B (hereinafter alternatively collectively referred to as processor 1904) and a memory 1906, such as random access memory (RAM). The computer 1902 may be coupled to, and/or integrated with, other devices, including input/output (I/O) devices such as a keyboard 1914, a cursor control device 1916 (e.g., a mouse, a pointing device, pen and tablet, touch screen, multi-touch device, etc.) and a printer 1928. In one or more embodiments, computer 1902 may be coupled to, or may comprise, a portable or media viewing/listening device 1932 (e.g., an MP3 player, IPOD, NOOK, portable digital video player, cellular device, personal digital assistant, etc.). In yet another embodiment, the computer 1902 may comprise a multi-touch device, mobile phone, gaming system, internet enabled television, television set top box, or other internet enabled device executing on various platforms and operating systems.

In one embodiment, the computer 1902 operates by the hardware processor 1904A performing instructions defined by the computer program 1910 (e.g., a computer-implemented tomography application) under control of an operating system 1908. The computer program 1910 and/or the operating system 1908 may be stored in the memory 1906 and may interface with the user and/or other devices to accept input and commands and, based on such input and commands and the instructions defined by the computer program 1910 and operating system 1908, to provide output and results.

Output/results may be presented on the display 1922 or provided to another device for presentation or further processing or action. In one embodiment, the display 1922 comprises a liquid crystal display (LCD) having a plurality of separately addressable liquid crystals. Alternatively, the display 1922 may comprise a light emitting diode (LED) display having clusters of red, green and blue diodes driven together to form full-color pixels. Each liquid crystal or pixel of the display 1922 changes to an opaque or translucent state to form a part of the image on the display in response to the data or information generated by the processor 1904 from the application of the instructions of the computer program 1910 and/or operating system 1908 to the input and commands. The image may be provided through a graphical user interface (GUI) module 1918. Although the GUI module 1918 is depicted as a separate module, the instructions performing the GUI functions can be resident or distributed in the operating system 1908, the computer program 1910, or implemented with special purpose memory and processors.

In one or more embodiments, the display 1922 is integrated with/into the computer 1902 and comprises a multi-touch device having a touch sensing surface (e.g., track pod or touch screen) with the ability to recognize the presence of two or more points of contact with the surface. Examples of multi-touch devices include mobile devices (e.g., IPHONE, NEXUS S, DROID devices, etc.), tablet computers (e.g., IPAD, HP TOUCHPAD, SURFACE Devices, etc.), portable/handheld game/music/video player/console devices (e.g., IPOD TOUCH, MP3 players, NINTENDO SWITCH, PLAYSTATION PORTABLE, etc.), touch tables, and walls (e.g., where an image is projected through acrylic and/or glass, and the image is then backlit with LEDs).

Some or all of the operations performed by the computer 1902 according to the computer program 1910 instructions may be implemented in a special purpose processor 1904B. In this embodiment, some or all of the computer program 1910 instructions may be implemented via firmware instructions stored in a read only memory (ROM), a programmable read only memory (PROM) or flash memory within the special purpose processor 1904B or in memory 1906. The special purpose processor 1904B may also be hardwired through circuit design to perform some or all of the operations to implement the present invention. Further, the special purpose processor 1904B may be a hybrid processor, which includes dedicated circuitry for performing a subset of functions, and other circuits for performing more general functions such as responding to computer program 1910 instructions. In one embodiment, the special purpose processor 1904B is an application specific integrated circuit (ASIC), field programmable gate array (FPGA), configured or adapted for performing or executing machine learning (e.g., algorithms) or artificial intelligence, or a graphics processing unit (GPU).

The computer 1902 may also implement a compiler 1912 that allows an application or computer program 1910 written in a programming language such as C, C++, Assembly, SQL, PYTHON, PROLOG, MATLAB, RUBY, RAILS, HASKELL, or other language to be translated into processor 1904 readable code. Alternatively, the compiler 1912 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1910 accesses and manipulates data accepted from I/O devices and stored in the memory 1906 of the computer 1902 using the relationships and logic that were generated using the compiler 1912.

The computer 1902 also optionally comprises an external communication device such as a modem, satellite link, Ethernet card, or other device for accepting input from, and providing output to, other computers 1902.

In one embodiment, instructions implementing the operating system 1908, the computer program 1910, and the compiler 1912 are tangibly embodied in a non-transitory computer-readable medium, e.g., data storage device 1920, which could include one or more fixed or removable data storage devices, such as a zip drive, floppy disc drive 1924, hard drive, CD-ROM drive, tape drive, etc. Further, the operating system 1908 and the computer program 1910 are comprised of computer program 1910 instructions which, when accessed, read and executed by the computer 1902, cause the computer 1902 to perform the steps necessary to implement and/or use the present invention or to load the program of instructions into a memory 1906, thus creating a special purpose data structure causing the computer 1902 to operate as a specially programmed computer executing the method steps described herein. Computer program 1910 and/or operating instructions may also be tangibly embodied in memory 1906 and/or data communications devices 1930, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1902.

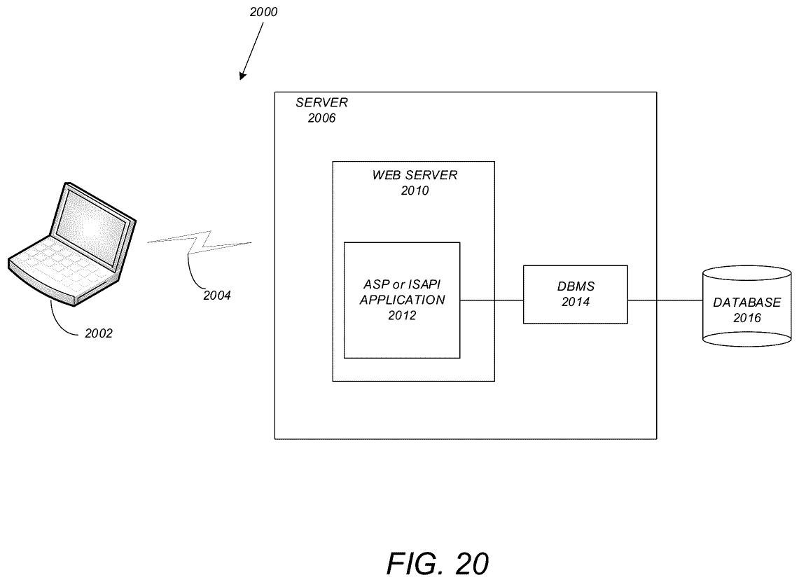

FIG. 20 schematically illustrates a typical distributed/cloud-based computer system 2000 using a network 2004 to connect client computers 2002 to server computers 2006. A typical combination of resources may include a network 2004 comprising the Internet, LANs (local area networks), WANs (wide area networks), SNA (systems network architecture) networks, or the like, clients 2002 that are personal computers or workstations (as set forth in FIG. 19), and servers 2006 that are personal computers, workstations, minicomputers, or mainframes (as set forth in FIG. 19). However, it may be noted that different networks such as a cellular network (e.g., GSM [global system for mobile communications] or otherwise), a satellite based network, or any other type of network may be used to connect clients 2002 and servers 2006 in accordance with embodiments of the invention.

A network 2004 such as the Internet connects clients 2002 to server computers 2006. Network 2004 may utilize ethernet, coaxial cable, wireless communications, radio frequency (RF), etc. to connect and provide the communication between clients 2002 and servers 2006. Further, in a cloud-based computing system, resources (e.g., storage, processors, applications, memory, infrastructure, etc.) in clients 2002 and server computers 2006 may be shared by clients 2002, server computers 2006, and users across one or more networks. Resources may be shared by multiple users and can be dynamically reallocated per demand. In this regard, cloud computing may be referred to as a model for enabling access to a shared pool of configurable computing resources.

Clients 2002 may execute a client application or web browser and communicate with server computers 2006 executing web servers 2010. Such a web browser is typically a program such as MICROSOFT INTERNET EXPLORER/EDGE, MOZILLA FIREFOX, OPERA, APPLE SAFARI, GOOGLE CHROME, etc. Further, the software executing on clients 2002 may be downloaded from server computer 2006 to client computers 2002 and installed as a plug-in or ACTIVEX control of a web browser. Accordingly, clients 2002 may utilize ACTIVEX components/component object model (COM) or distributed COM (DCOM) components to provide a user interface on a display of client 2002. The web server 2010 is typically a program such as MICROSOFT'S INTERNET INFORMATION SERVER.

Web server 2010 may host an Active Server Page (ASP) or Internet Server Application Programming Interface (ISAPI) application 2012, which may be executing scripts. The scripts invoke objects that execute business logic (referred to as business objects). The business objects then manipulate data in database 2016 through a database management system (DBMS) 2014. Alternatively, database 2016 may be part of, or connected directly to, client 2002 instead of communicating/obtaining the information from database 2016 across network 2004. When a developer encapsulates the business functionality into objects, the system may be referred to as a component object model (COM) system. Accordingly, the scripts executing on web server 2010 (and/or application 2012) invoke COM objects that implement the business logic. Further, server 2006 may utilize MICROSOFT'S TRANSACTION SERVER (MTS) to access required data stored in database 2016 via an interface such as ADO (Active Data Objects), OLE DB (Object Linking and Embedding DataBase), or ODBC (Open DataBase Connectivity).

Generally, these components 2000-2016 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 2002 and 2006 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 2002 and 2006. Embodiments of the invention are implemented as a software/CAD application on a client 2002 or server computer 2006. Further, as described above, the client 2002 or server computer 2006 may comprise a thin client device or a portable device that has a multi-touch-based display.

### Device, System, and Method Embodiments

Devices, Systems, and Methods according to embodiments of the present invention include, but are not limited to, the following (referring also to FIGS. 1-20).
1 A computer-implemented method useful for performing seismic tomography, comprising (referring to FIGS. 1, 2, and 4 and 6):
   Obtaining 100, 200, (e.g., in a computer or computer or computer system), seismic data comprising distributed acoustic sensing (DAS) data, comprising at least one of P-wave or S-wave travel times from a plurality of seismic events 304 to a plurality of recording stations 302 coupled to a network of optical fibers 300 in a geological structure 308; and
   generating 102 tomography data 600, (e.g., in the computer or computer system), from the seismic data, wherein the tomography data is useful for characterizing the geological structure.
2 The method of clause 1, further comprising:
   (a) iteratively minimizing 202 (e.g., in the computer or computer system) an objective function of the travel times, a model for coordinates of the seismic events, and a fixed velocity structure of the waves, comprising updating the coordinates at each iteration step until the model fits the travel times to a predetermined level of accuracy;
   (b) iteratively minimizing 204 (e.g., in the computer or computer system) the objective function of the travel times, a velocity model for a velocity structure, and the coordinates outputted from step (a), comprising updating the velocity structure at each iteration step until the velocity model fits the travel times to a predetermined level of accuracy;
   (c) iteratively repeating 206 the steps (a) and (b) (e.g., in the computer or computer system) using the updated velocity structure outputted from (b) as the fixed velocity structure in a next iteration of step (a), until the coordinates and the velocity structure outputted from steps (a) and (b) do not change by more than 1%; and
   (d) outputting the tomography data 208 (e.g., from the computer or computer system) comprising the velocity structure after the step (c).
3. The method of clause 2, comprising generating and displaying a tomographic map of the velocity structure (e.g., in the computer or computer system or another computer or computer system) comprising velocity of the waves as a function of the coordinates and a 3D location with respect to the seismic events and the network of fibers.
4. The method of clause 1 or 2, wherein the DAS data comprises double difference data and the models each comprise an Eikonal operator.
5 The method of clause 1, 2, or 3 further comprising separately performing the minimizing of the objective function (in the computer or the computer system) for the model comprising a P-wave model and the model comprising an S wave model.
6. The method of any of the clauses 1-4, wherein the fibers comprise telecommunication optical fibers 300 and the recording stations 302 obtain the DAS data from measurements of backscattering of laser pulses propagating in the fibers in response to deformations of the ground in contact with the fibers and caused by at least a subset of the seismic events.
7. The method of any of the clauses 1-5, wherein the seismic events comprise at least 1000 seismic events recorded at recording stations 306 using a method different from DAS.
8 The method of any of the clauses 1-6, wherein the seismic events comprise an earthquake, volcanic activity, an explosion from an active survey explosive source, a deformation of the ground caused by a hammer, or a deformation of the ground caused by a vehicle.
9 The method of any of the clauses 1-7, wherein the DAS data comprises travel times associated with seismic events having a threshold signal to noise ratio.
10 The method of any of the clauses 1-8, wherein the tomographic data is generated with an accuracy wherein the tomographic map 600 has a spatial resolution of less than 10 km or less than 1 km.
11. The method of any of the clauses 1-9, wherein the seismic events are located within 200 km of the network of fibers and the tomographic data generates a map 600 of an area enclosing the network of optical fibers and extending no more than 10 km from a furthest extremity of the network of fibers.
12. The method of any of the clauses 1-10, further comprising generating the tomographic map 1100 of at least one of a geothermal anomaly (temperature variation as a function of position), faults or anomalies in a fault structure, a magmatic system, an oil field, a natural gas field, a composition of the geological structure, or a geophysical structure.
13. The method of any of the clauses 1-11, further comprising using the tomographic map for geothermal prospect exploration, subsurface monitoring for carbon sequestration, characterization of subsurface properties for earthquake amplification factor estimation, earthquake prediction, detection or alarm systems, or volcanic eruption detection, prediction or alarm systems.
14. The method of any of the clauses 1-12, wherein the travel times are determined from DAS data using a machine learning algorithm.
15. A computer-implemented system 1900, comprising:
   (a) a computer 1902 having a memory;
   (b) a processor executing on the computer;
   (c) the memory storing a set of instructions, wherein the set of instructions, when executed by the processor cause the processor to perform operations comprising:
obtaining seismic data comprising distributed acoustic sensing (DAS) data, comprising at least one of P-wave or S-wave travel times from a plurality of seismic events to a plurality of recording stations 302 coupled to a network of optical fibers 300 in a geological structure 308; and
generating tomography data 600 from the DAS data, wherein tomography data is useful for characterizing the geological structure.
16. The system of clause 15, wherein the set of instructions, when executed by the processor cause the processor to perform operations comprising:
   (a) iteratively minimizing an objective function of the travel times, a model for coordinates of the seismic events, and a fixed velocity structure of the waves, comprising updating the coordinates at each iteration step until the model fits the travel times to a predetermined level of accuracy;
   (b) iteratively minimizing the objective function of the travel times, a model for the velocity structure, and the updated coordinates outputted from step (a), comprising updating the velocity structure at each iteration step until the model fits the travel times to a predetermined level of accuracy;
   (c) iteratively repeating the steps (a) and (b) using the updated velocity structure outputted from (b) as the fixed velocity structure in a next iteration of step (a), until the coordinates and the velocity structure outputted from steps (a) and (b) do not change by more than 1%; and
   (d) outputting the tomography data comprising the velocity structure after the step (c).
17. The system of claim 15 or 16, further comprising
   the network 1931 of telecommunication optical fibers and the recording stations 302 coupled to the optical fibers;
   a laser 1931a or laser source for outputting laser pulses (comprising electromagnetic radiation, e.g. corresponding to telecom wavelengths) into the fibers; and
   the recording stations comprising detectors 1931b for detecting the backscattering in response to deformations of the ground in contact with the fibers and caused by at least a subset of the seismic events.
18. The system of any of the clauses 15-17 performing the method of any of the clauses 1-14.
19. A computer-readable storage medium storing instructions that, when executed by a computing system, cause the computing system to perform a process comprising.
   obtaining seismic data comprising distributed acoustic sensing (DAS) data, comprising at least one of P-wave or S-wave travel times from a plurality of seismic events to a plurality of recording stations coupled to a network of optical fibers in a geological structure; and
   generating tomography data from the seismic data, wherein the tomography data is useful for characterizing the geological structure.
20 The medium of clause 19, wherein the process further comprises:
   (a) iteratively minimizing an objective function of the travel times, a model for coordinates of the seismic events, and a fixed velocity structure of the waves, comprising updating the coordinates at each iteration step until the model fits the travel times to a predetermined level of accuracy;
   (b) iteratively minimizing the objective function of the travel times, a model for the velocity structure, and the updated coordinates outputted from step (a), comprising updating the velocity structure at each iteration step until the model fits the travel times to a predetermined level of accuracy;
   (c) iteratively repeating the steps (a) and (b) using the updated velocity structure outputted from (b) as the fixed velocity structure in a next iteration of step (a), until the coordinates and the velocity structure outputted from steps (a) and (b) do not change by more than 1%; and
   (d) outputting the tomography data comprising the velocity structure after the step (c).
20 The medium of clauses 19 or 20, performing the method of any of the clauses 1-14 and/or performed using the system of any of the clauses 15-18.
21 The medium, system, or method of any of the clauses 1-20, wherein the fiber comprises a single fiber 300 or a plurality of fibers, wherein the fiber(s) are in a fiber optic cable containing a multiple fibers (most of which are being used for telecom (telecommunications fibers).
22. The medium, system or method of any of the clauses 1-21, wherein the fiber(s) is/are a dark telecommunications fiber.

### REFERENCES

The following references are incorporated by reference herein.
J. B. Lowenstern, R. B. Smith, D. P. Hill, Philosophical transactions of the royal society A: Mathematical, Physical and Engineering Sciences 364, 2055 (2006).
A. Bevilacqua, et al., Journal of Geophysical Research: Solid Earth 123, 5466 (2018).
N. A. of Sciences, Engineering & Medicine, Volcanic eruptions and their repose, unrest, precursors, and timing (National Academies Press, 2017).
M. Paulatto, et al., EarthArXiv (2022).
H.-H. Huang, et al., Science 348, 773 (2015).
R. Maguire, et al., Science 378, 1001 (2022).
C. J. Wilson, et al., Nature Reviews Earth & Environment 2, 610 (2021).
R. A. Bailey, G. B. Dalrymple, M. A. Lanphere, Journal of Geophysical Research 81, 725 (1976).
W. Hildreth, C. J. Wilson, Journal of Petrology 48, 951 (2007).
D. P. Hill, Geological Society, London, Special Publications 269, 1 (2006).
J. C. Savage, R. S. Cockerham, Journal of Geophysical Research: Solid Earth 89, 8315 (1984).
E. Montgomery-Brown, D. R. Shelly, P. A. Hsieh, Geophysical Research Letters 46, 3698 (2019).
B. Q. Li, J. D. Smith, Z. E. Ross, Science Advances 7, eabi8368 (2021).
A. Pitt, D. Hill, Geophysical Research Letters 21, 1679 (1994).
E. E. Brodsky, S. G. Prejean, Journal of Geophysical Research: Solid Earth 110 (2005).
D. S. Dreger, H. Tkalcic, M. Johnston, Science 288, 122 (2000).
M. Battaglia, P. Segall, C. Roberts, Journal of Volcanology and Geothermal Research 127, 219 (2003).
P. Tizzani, et al., Geology 37, 63 (2009).
M. Sorey, B. Kennedy, W. Evans, C. Farrar, G. Suemnicht, Journal of Geophysical Research: Solid Earth 98, 15871 (1993).
M. L. Sorey, G. A. Suemnicht, N. C. Sturchio, G. A. Nordquist, Journal of Volcanology and Geothermal Research 48, 229 (1991).
G. Lucic, J. Stix, B. Wing, Journal of Geophysical Research: Solid Earth 120, 2262 (2015).
A. J. Hotovec-Ellis, et al., Science Advances 4, eaat5258 (2018).
D. P. Hill, E. Montgomery-Brown, D. R. Shelly, A. F. Flinders, S. Prejean, Journal of Volcanology and Geothermal Research 400, 106900 (2020).
W. Hildreth, Journal of Volcanology and Geothermal Research 341, 269 (2017).
W.C. Hammond, C. Kreemer, I. Zaliapin, G. Blewitt, Journal of Geophysical Research: Solid Earth, 124, 6 (2019).
D. R. Shelly, W. L. Ellsworth, D. P. Hill, Journal of Geophysical Research: Solid Earth, 12, 3 (2016).
G. A. Gualda, M. S. Ghiorso, Contributions to Mineralogy and Petrology, 166 (2013).
T. W. Sisson, C. R. Bacon, Geology, 27, 7 (1999).
P. Dawson, J. Evans, H. Iyer, Journal of Geophysical Research: Solid Earth 95, 11021 (1990).
D. Seccia, C. Chiarabba, P. De Gori, I. Bianchi, D. Hill, Journal of Geophysical Research: Solid Earth 116 (2011).
G. Lin, Journal of volcanology and geothermal research 296, 19 (2015).
A. F. Flinders, et al., Geology 46, 799 (2018).
Z. Zhan, Seismological Research Letters 91, 1 (2020).
N. J. Lindsey, E. R. Martin, Annual Review of Earth and Planetary Sciences 49, 309 (2021).
P. Jousset, et al., Nature communications 13, 1753 (2022).
O. G. Flovenz, et al., Nature Geoscience 15, 397 (2022).
A. Fichtner, et al., The Seismic Record 2, 148 (2022).
E. Biondi, X. Wang, E. F. Williams, Z. Zhan, Seismological Society of America 94, 318 (2023).
F. Waldhauser, D. Schaff, J. Geophys. Res 113, B08311 (2008).
E.-J. Lee, et al., Journal of Geophysical Research: Solid Earth 119, 6421 (2014).
J. R. Peacock, M. T. Mangan, D. McPhee, P. E. Wannamaker, Geophysical Research Letters 43, 7953 (2016).
I. Koulakov, et al., Journal of Geophysical Research: Solid Earth 112 (2007).
S. Hurwitz, C. D. Farrar, C. F. Williams, Journal of volcanology and geothermal research 198, 233 (2010).
K. Sieh, M. Bursik, Journal of Geophysical Research: Solid Earth 91, 12539 (1986).
L. C. Pakiser, F. Press, M. F. Kane, Geological Society of America Bulletin 71, 415 (1960).
J. R. Peacock, M. T. Mangan, D. McPhee, D. A. Ponce, Journal of Geophysical Research: Solid Earth 120, 7273 (2015).
R. Maguire, et al., Geochemistry, Geophysics, Geosystems 23, e2022GC010446 (2022).
D. P. Hill, Journal of Geophysical Research 81, 745 (1976).
A. Stroujkova, P. Malin, Bulletin of the Seismological Society of America 90, 500 (2000).
N. Nakata, D. R. Shelly, Geophysical Research Letters 45, 3481 (2018).
E. Montgomery-Brown, et al., Geophysical Research Letters 42, 5250 (2015).
R. B. Herrmann, Seismological Research Letters 84, 1081 (2013).
T. M. Brocher, Bulletin of the seismological Society of America 95, 2081 (2005).
C. Jiang, B. Schmandt, J. Farrell, F. C. Lin, K. M. Ward, Geology, 46, 8 (2018).
W. Zhu, E. Biondi, J. Li, Z. E. Ross, Z. Zhan, arXiv preprint (2023).
W. Zhu, G. C. Beroza, Geophysical Journal International 216, 261 (2019).
O. Ronneberger, P. Fischer, T. Brox, International Conference on Medical image computing and computer-assisted intervention (Springer, 2015), pp. 234-241.
J. VanDecar, R. Crosson, Bulletin of the Seismological Society of America 80, 150 (1990).
J. Li, W. Zhu, E. Biondi, Z. Zhan, Nature communications 14, 4181 (2023).
H. Zhang, C. Thurber, Pure and Applied Geophysics 163, 373 (2006).
R.-E. Plessix, Geophysical Journal International 167, 495 (2006).
S. Li, A. Vladimirsky, S. Fomel, Geophysics 78, U89 (2013).
P. Tong, Journal of Geophysical Research: Solid Earth 126, e2021JB021818 (2021).
E. Biondi, G. Barnier, R. G. Clapp, F. Picetti, S. Farris, Computers & Geosciences 154, 104790 (2021).
M. C. White, H. Fang, N. Nakata, Y. Ben-Zion, Seismological Research Letters 91, 2378 (2020).
F. Waldhauser, W. L. Ellsworth, Bulletin of the seismological society of America 90, 1353 (2000).
D. C. Liu, J. Nocedal, Mathematical programming 45, 503 (1989).
P. Small, et al., Seismological Research Letters 88, 1539 (2017).
C. A. Zelt, Geophysical Journal International 135, 1101 (1998).
H. H. Huang, Y. M. Wu, X. Song, C. H. Chang, S. J. Lee, T. M. Chang, H. H. Hsieh, Earth and Planetary Science Letters 392, 177 (2014).

Further information can be found in Sci Adv. 2023 Oct. 20; 9 (42): eadi9878.Published online 2023 Oct. 18. doi: 10 1126/s 98.78 An upper-crust lid over the Long Valley magma chamber by Extore Biondi, et. al . . . , and supporting information.

Data and materials availability: All data needed to evaluate the conclusions in the paper are present herein. Seismic data at conventional stations are from the Northern California Earthquake Data Center (https://ncedc.org/) and the Nevada Seismic Network (http://www.seismo unr edu/). The DAS traveltimes of the employed events and velocity models are available at the Zenodo repo: https://doi.org/10.5281/zenodo.8270895

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-implemented method useful for performing seismic tomography, comprising:
obtaining seismic data comprising distributed acoustic sensing (DAS) data, comprising at least one of P-wave or S-wave travel times from a plurality of seismic events to a plurality of recording stations coupled to a network of optical fibers in a geological structure; and
generating tomography data from the seismic data, wherein the tomography data is useful for characterizing the geological structure.

2. The method of claim 1, further comprising:
(a) iteratively minimizing an objective function of the travel times, a model for coordinates of the seismic events, and a fixed velocity structure of the waves, comprising updating the coordinates at each iteration step until the model fits the travel times to a predetermined level of accuracy;
(b) iteratively minimizing the objective function of the travel times, a velocity model for a velocity structure, and the coordinates outputted from step (a), comprising updating the velocity structure at each iteration step until the velocity model fits the travel times to a predetermined level of accuracy;
(c) iteratively repeating the steps (a) and (b) using the updated velocity structure outputted from (b) as the fixed velocity structure in a next iteration of step (a), until the coordinates and the velocity structure outputted from steps (a) and (b) do not change by more than 1%; and
(d) outputting the tomography data comprising the velocity structure after the step (c).

3. The method of claim 2, comprising generating and displaying a tomographic map of the velocity structure comprising velocity of the waves as a function of the coordinates and a 3D location with respect to the seismic events and the network of fibers.

4. The method of claim 2, wherein the DAS data comprises double difference data and the models each comprise an Eikonal operator.

5. The method of claim 2, further comprising separately performing the minimizing of the objective function for the model comprising a P-wave model and the model comprising an S wave model.

6. The method of claim 1, wherein the fibers comprise telecommunication optical fibers and the recording stations obtain the DAS data from measurements of backscattering of laser pulses propagating in the fibers in response to deformations of the ground in contact with the fibers and caused by at least a subset of the seismic events.

7. The method of claim 1, wherein the seismic events comprise at least 1000 seismic events recorded using a method different from DAS.

8. The method of claim 1, wherein the seismic events comprise an earthquake, volcanic activity, an explosion from an active survey explosive source, a deformation of the ground caused by a hammer, or a deformation of the ground caused by a vehicle.

9. The method of claim 1, wherein the DAS data comprises travel times associated with seismic events having a threshold signal to noise ratio.

10. The method of claim 1, wherein the tomographic data is generated with an accuracy wherein the tomographic map has a spatial resolution of less than 10 km or less than 1 km.

11. The method of claim 1, wherein the seismic events are located within 200 km of the network of fibers and the tomographic data generates a map of an area enclosing the network of optical fibers and extending no more than 10 km from a furthest extremity of the network of fibers.

12. The method of claim 1, further comprising generating the tomographic map of at least one of a geothermal anomaly (temperature variation as a function of position), faults or anomalies in a fault structure, a magmatic system, an oil field, a natural gas field, a composition of the geological structure, or a geophysical structure.

13. The method of claim 1, further comprising using the tomographic map for geothermal prospect exploration, subsurface monitoring for carbon sequestration, characterization of subsurface properties for earthquake amplification factor estimation, earthquake prediction, detection or alarm systems, or volcanic eruption detection, prediction or alarm systems.

14. The method of claim 2, wherein the travel times are determined from DAS data using a machine learning algorithm.

15. A computer-implemented system, comprising:
(a) a computer having a memory;
(b) a processor executing on the computer;
(c) the memory storing a set of instructions, wherein the set of instructions, when executed by the processor cause the processor to perform operations comprising:
obtaining seismic data comprising distributed acoustic sensing (DAS) data, comprising at least one of P-wave or S-wave travel times from a plurality of seismic events to a plurality of recording stations coupled to a network of optical fibers in a geological structure; and
generating tomography data from the DAS data, wherein tomography data is useful for characterizing the geological structure.

16. The system of claim 15, wherein the set of instructions, when executed by the processor cause the processor to perform operations comprising:
(a) iteratively minimizing an objective function of the travel times, a model for coordinates of the seismic events, and a fixed velocity structure of the waves, comprising updating the coordinates at each iteration step until the model fits the travel times to a predetermined level of accuracy;
(b) iteratively minimizing the objective function of the travel times, a model for the velocity structure, and the updated coordinates outputted from step (a), comprising updating the velocity structure at each iteration step until the model fits the travel times to a predetermined level of accuracy;
(c) iteratively repeating the steps (a) and (b) using the updated velocity structure outputted from (b) as the fixed velocity structure in a next iteration of step (a), until the coordinates and the velocity structure outputted from steps (a) and (b) do not change by more than 1%; and
(d) outputting the tomography data comprising the velocity structure after the step (c).

17. The system of claim 15, further comprising
the network of telecommunication optical fibers and the recording stations coupled to the optical fibers;
a laser source for outputting laser pulses into the fibers; and
the recording stations comprising detectors for detecting the backscattering in response to deformations of the ground in contact with the fibers and caused by at least a subset of the seismic events

18. A computer-readable storage medium storing instructions that, when executed by a computing system, cause the computing system to perform a process comprising:
obtaining seismic data comprising distributed acoustic sensing (DAS) data, comprising at least one of P-wave or S-wave travel times from a plurality of seismic events to a plurality of recording stations coupled to a network of optical fibers in a geological structure; and
generating tomography data from the seismic data, wherein the tomography data is useful for characterizing the geological structure.

19. The medium of claim 18, wherein the process further comprises:
(a) iteratively minimizing an objective function of the travel times, a model for coordinates of the seismic events, and a fixed velocity structure of the waves, comprising updating the coordinates at each iteration step until the model fits the travel times to a predetermined level of accuracy;
(b) iteratively minimizing the objective function of the travel times, a model for the velocity structure, and the updated coordinates outputted from step (a), comprising updating the velocity structure at each iteration step until the model fits the travel times to a predetermined level of accuracy;
(c) iteratively repeating the steps (a) and (b) using the updated velocity structure outputted from (b) as the fixed velocity structure in a next iteration of step (a), until the coordinates and the velocity structure outputted from steps (a) and (b) do not change by more than 1%; and
(d) outputting the tomography data comprising the velocity structure after the step (c).

20. The medium of claim 20, wherein the seismic events comprise an earthquake, volcanic activity, an explosion from an active survey explosive source, a deformation of the ground caused by a hammer, or a deformation of the ground caused by a vehicle.
